(19) United States
(12) Patent Application Publication
(10) Pub. No.: US 2008/0162475 A1
(43) Pub. Date: Jul. 3, 2008

(54) Click-fraud detection method

(76) Inventors: Anthony F. Meggs, (US); Jim Gillespie, (US)

Correspondence Address: AKERMAN SENTERFITT, P.O. BOX 3188, WEST PALM BEACH, FL, 33402-3188, US

(21) Appl. No.: 11/648,576

(22) Filed: Jan. 3, 2007

(51) Int. Cl. G06F 17/30

(52) U.S. Cl. 707/6; 707/E17.014

(57) ABSTRACT

A method for determining whether clicks on results in a search are fraudulent is provided. The method includes monitoring a pattern of clicks on links presented to a user as a result of a search request by the user; and conducting additional analysis of the links clicked on by the user if the monitored pattern of clicks falls within pre-determined parameters. A second method of detecting click fraud is also provided. The method includes: monitoring links clicked on by a user; adjusting search results presented to a user in response to a user's search when the user clicks on links associated with the search results in a pattern that fall within pre-determined parameters.

### FIELD OF THE INVENTION

The present invention relates generally to detecting whether clicks on links displayed as search results are made by interested internet users or are made to affect advertising revenues. More particularly, the present invention relates to analyzing and characterizing clicks made by internet users.

### BACKGROUND OF THE INVENTION

Search engines such as Google, Yahoo and others generate revenue based on internet users clicking on links that are displayed as part of, or along side of search results, for example a search engine may generate a standard set of search results and addition search results may be displayed on other parts of the computer screen. Often advertisers may pay premiums to have extra links appear along side standard search results. Further, websites can receive advertising revenue when links displayed on the website are clicked on. There are many other ways that revenue may be generated by clicking on links. Clicking on links generates revenue for a hosting site. The revenue is generated by an advertiser paying the hosting site an amount of money when links are clicked on. Common to many of the ways advertising costs are determined is to count how many times a link is clicked on. The clicking of following links can generate additional costs, but again, the basic way of determining advertising costs is to count how may times a link is clicked on.

Unfortunately, some have sought to abuse the revenue generating process. Some such abuses are referred to as click fraud. At least three types of click fraud have emerged. In one case, rivals will click links for their competitors in order to increase the amount of times a competitor's links are clicked on and thus drive up advertising costs for their competitor's. In another type of click fraud, website owners will click on ads appearing on their own websites in order to boost their advertising revenue. In other words, these website owners defraud their own advertising clients to make their websites appear as though there is more traffic viewing the website and clicking on the advertisements then there really are.

A third type of click fraud can occur when an internet user has voluntarily allowed themselves to have some or all aspects of their internet usage monitored. Often rewards are offered if internet users permit monitoring of internet usage. The rewards are payed for by entities wanting the data generated by the monitored internet usage or advertisers that tailor advertiser to a particular user based on past internet usage patterns. An advertisement may pay a certain amount per click to the owner of the website that displays the adds and a certain amount to the user that clicks on the link. The rewards can be paid to the user or some third party entity designated by the user (i.e. a charity, a school, political cause, ministry or other organization). This type of fraud is motivated by a user's desire to click-through ads simply to benefit themselves or third party designee, without any intention or desire to learn about the sponsor's products and services, i.e. the member has little or no motivation to find information from the search, but instead is only motivated to directly or indirectly benefit by maximizing the amount of money that can be repurposed from click-ad revenue.

Some cynically point out that website owners (of even large and popular websites) and companies that own and host search engines have no motivation to combat click fraud because of the large amounts of revenue that they themselves may loose if click fraud is combated.

However, others argue that in the long run, companies will make more money when they provide trustworthy and valuable service for their clients, and by combating click fraud, companies will better serve their clients, and thus generate more revenue then any short term gain the practice of click fraud may yield. Further, advertisers would like to reduce advertising costs and one way to accomplish this would be to reduce advertising dollars wasted on perpetrators of click fraud.

Accordingly, it is desirable to provide a method for detecting or identify patterns indicative of various types of click fraud. In addition, it is desirable to formulate advertisement payment practices that reduce the amount of money is lost to various types of click fraud.

### SUMMARY OF THE INVENTION

The foregoing needs are met, to a great extent, by the present invention, wherein in some embodiments a method is provided that detects click fraud. In other embodiments of the invention, a method is provided that identifies patterns of click fraud.

In accordance with one embodiment of the present invention, a method of detecting click fraud is provided. The method includes: monitoring links clicked on by a user; adjusting search results presented to a user in response to a user's search when the user clicks on links associated with the search results in a pattern that fall within pre-determined parameters.

In accordance with another embodiment of the present invention a method of detecting click fraud behavior is provided. The method includes: monitoring a pattern of clicks on links presented to a user as a result of a search request by the user; adjusting the search results presented to the user in future search requests when past search requests from that user result in the user forming a pattern of clicking on links presented in the past search results according to predetermined parameters; and conducting additional analysis of the links clicked on by the user in the adjusted search results and based on the additional analysis doing one of the following two steps: resuming the presentation of search results to the user to a pre-adjusted level; and stopping the presentation of search results to the user.

In accordance with still another embodiment of the present invention, a method of detecting click fraud behavior is provided. The method includes: monitoring a pattern of clicks on links presented to a user as a result of a search request by the user; and conducting additional analysis of the links clicked on by the user if the monitored pattern of clicks falls within pre-determined parameters.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a flowchart illustrating steps that may be followed in accordance with one embodiment of the invention.

FIG. 2 is a flowchart illustrating steps that may be followed in accordance with another embodiment of the invention.

FIG. 3 is a flowchart illustrating steps that optionally may be followed as a subroutine of the flow charts of FIGS. 1 and 2.

FIG. 4 is a table illustrating how click rate, click coverage, search relevancy correspond to click characterization.

FIG. 5 is a waveform illustrating expected search burst trends.

FIG. 6 is a waveform illustrating click fraud transition.

FIG. 7 is a waveform illustrating automated fraud transition.

FIG. 8 is a waveform illustrating nominal, to manual, to automated fraud transitions.

FIG. 9 is a flowchart illustrating steps that optionally may be followed as a subroutine of the flow charts of FIGS. 1 and 2.

### DETAILED DESCRIPTION

The invention will now be described with reference to the drawing figures, in which like reference numerals refer to like parts throughout. An embodiment in accordance with the present invention provides a method to detect if clicks on advertised links are fraudulent. In some embodiments of the invention, circumstances surrounding the clicks are analyzed and to determine if a link was clicked on because a user was interested in going to the site directed to by the link, (a legitimate click) or whether the link was clicked on in order to manipulate click counters counting the number of times a link was clicked on (a fraudulent click). The proceeding sentence provides examples of legitimate clicks and fraudulent clicks, and does not dispositively define the meaning of the terms legitimate and fraudulent clicks.

In other embodiments of the invention, methods are provided to reduce advertising fees that are spent on fraudulent clicks. Some embodiments of the invention are used with a permissive search agent such as Crossites, for example. Such search agents are described in U.S. patent application Ser. No. 11/267,210, filed Nov. 7, 2005, titled “Web-Based Incentive System and Method” which is incorporated herein by reference in its entirety.

In brief, a permissive search agent works in conjunction with a search engine such a Google, Yahoo, (for example) or any other search engine. A user has an account with the permissive search agent provider, and at the user's option, when the user conducts searches with certain search engines, the search engine and the permissive search agent with yield internet links as a result of the search. The results provided by the permissive search agent are sponsored by advertisers having an advertising agreement with the permissive search agent sponsor to provide benefits to users or a user's designee (a charity, school, political or religious group, etc.) that click on the advertisers links. For example, the benefits may include, frequent flier miles, monetary rewards, bonus points redeemable for goods or services or any other benefit. As a user (or user's designee) is provided with a benefit for clicking on links provided as search results, there is a potential for a user to abuse the permissive search system and click on links for which the user has no interested other then manipulating the accounting of rewards or increasing advertising fees for sponsors of links (competitors). Clicking on links for these manipulative purposes is exemplary of fraudulent clicks. Monitoring and/or analysis of a users activity can be done because the user of the permissive search agent has granted the operators of the permissive search agent permission to do so by downloading the permissive search agent and accepting the user agreement.

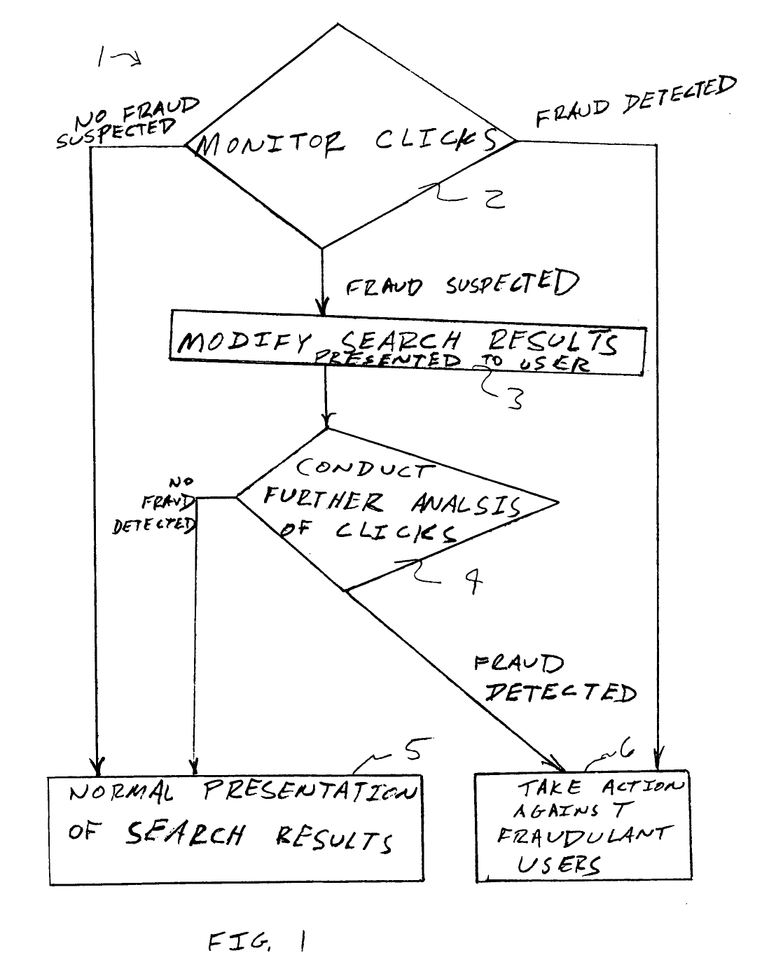

An embodiment of the present inventive method is illustrated in FIG. 1. The method 1 of FIG. 1 illustrates a method 1 of determining whether clicks are fraudulent or valid and what is done once the clicks have been determined to be valid or fraudulent. In the method 1, a user is monitored (step marked with reference number 2) regarding the links presented in search results and the user's clicking on those links. As the user's clicks are monitored, patterns may emerge that suggest that the user is performing litigate clicks (in such a case the method 1 proceeds to step 5), fraudulent clicks (in such a case the method 1 proceeds to step 6) or a pattern may emerge that could cause suspicion that many (if not all) of a user's click are fraudulent.

According to some embodiments of the invention, if fraudulent clicks are suspected, the next step 3 in the method 1 is accomplished. In some embodiments of the invention, billing advertisers and/or granting awards for making suspect clicks may be suspended until the clicks are shown to not be fraudulent.

In this step 3, the permissive search agent may alter or modify the search results in further searches carried out by the suspect user. Examples of modification, may include, but are not limited reducing and/or eliminating the amount of links returned as search results, reducing the amount of leads (notice to a merchant that the merchant can contact the user. The user gets a benefit if the merchant contacts the user) qualified leads (notice to a merchant that the merchant can contact the user. The user gets a benefit when the user is contacted if the user qualifies. Qualification can include answering certain questions, being a member of a targeted demographic group, etc.) and types of links such as competitors links.

The next step 4 in the method 1 shown in FIG. 1 is to analyze the clicking behavior in a more in-depth manner. The more in-depth analysis will be discussed in more detail below. If this analysis indicates that the clicking behavior is legitimate, the next step 5 is to remove the modifications of the search results and provide normal search results.

If the analysis conducted in step 4 indicates that the clicks are fraudulent, than the search agent may make take action against the fraudulent user. Examples of taking action against the fraudulent user may include suspending the account, termination the account, sending warnings to the user, and penalizing the users rewards account. Other embodiments of the invention may take any other suitable action against the user. Advertisers will not be billed nor will benefits be distributed for fraudulent clicks in some embodiments of the invention.

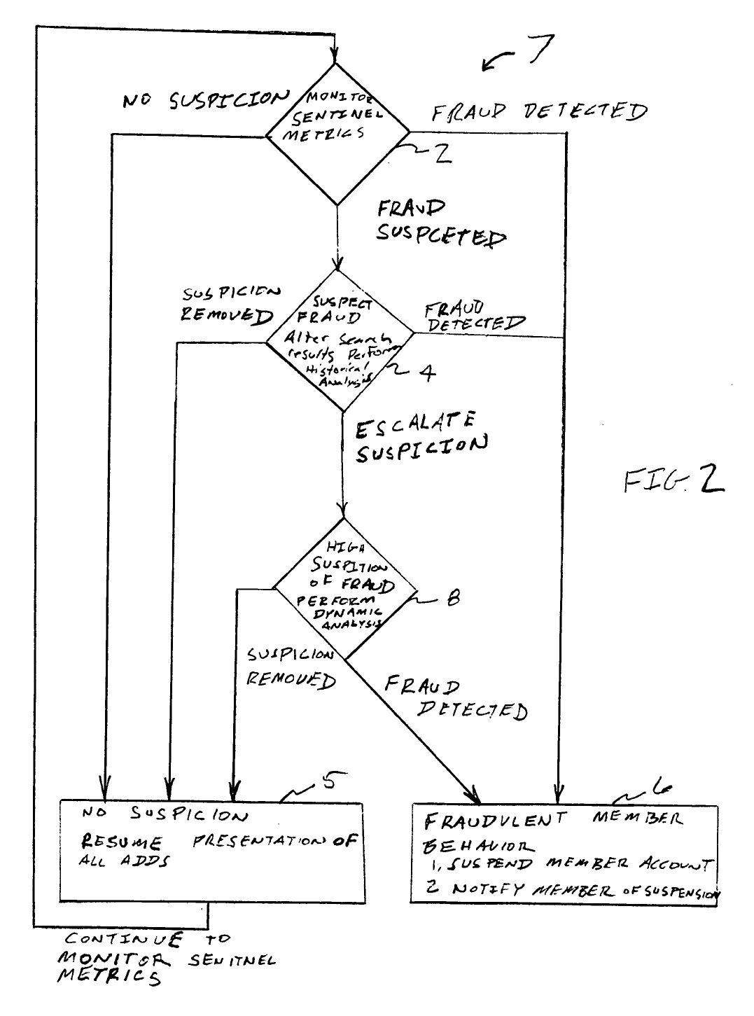

FIG. 2 illustrates a method 7 similar to the method 1 of FIG. 1 but the method 7 of FIG. 1 includes a extra analysis step 8. If, after the analysis conducted in step 4 (referred to in some embodiments as historical analyses, explained in more detail below) leads to neither the removal of suspicion of fraud with respect to the clicks, or detected of the clicks to be fraudulent, than step 8 is initiated.

In step 8, additional analysis on the click patterns of a user is conducted. In some embodiments of the invention, this additional analysis is referred to as dynamic analysis and will be discussed in depth below. In some embodiments of the invention, additional modifications to the search results may made similar to as described above. After the analysis is completed in step 8, the clicks are either deemed to be legitimate, and the method 7 moves to step 5 as described above or fraudulent in which case step 6 is then initiated as described above.

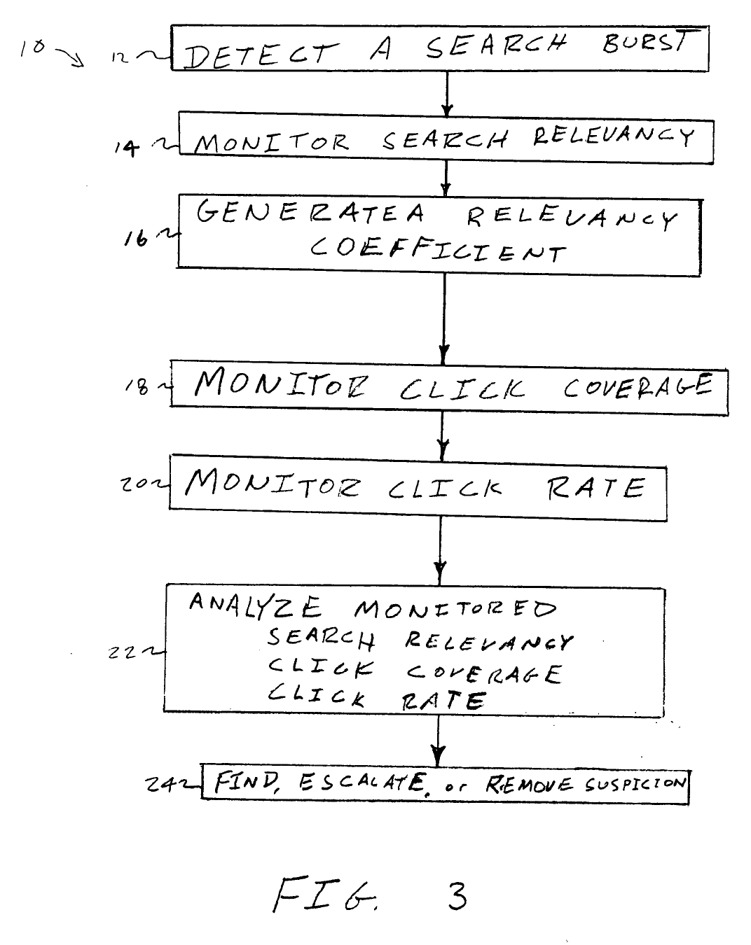

In some embodiments of the invention, step two of both the methods 1, 7 of FIGS. 1 and 2 includes the sub-method 10 shown in shown in FIG. 3. The method 10 of FIG. 3 outlines in detail the analysis and characterization of the clicks of step 2. In some embodiments of the invention, the metrics monitored and analyzed are referred to as sentinel metrics. The method 10 which in some embodiments is a subroutine of step 2 of the methods 1 and 7 includes seven steps 12-24. The first step 12 is to detect a search burst.

A search-burst can be defined according to specific needs of a particular search agent. In a generic example, a search-burst is a sequence of two or more searches conducted by a user occurring within a relatively short duration of each other. Generally a search burst is characterized by 2-10 searches within a 1-15 minute period; however, a search burst can extend beyond 15 minutes according to the skill level and other factors associated with the user. A search burst is associated with a member's quest to find specific information on a topic, product, or service, a search goal. Analyzing user behavior by search-bursts enhances the ability to ascertain whether or not fraudulent motives exists for a specific user; specifically, analyzing the number of clicks associated with each search in a search burst as well as the relevancy of all searches within the search burst.

The duration and number of searches within a search-burst are largely a function of end-user search skills and end-user knowledge of the information they are searching for, i.e. domain knowledge. For example, in a hypothetical case, an electrical engineer is the user and has been performing internet searches for 10 years. If the engineer were to perform a search for a specific type of circuit board, it would be expected that very few searches within a short duration of time before the engineer finds the desired information. The engineer not only possesses a knowledge of the domain searched (electrical engineering), but also possesses experience and skill in formulating advanced search strings to rapidly target the desired results.

On the other hand, if a grade school student with only a few weeks of internet search experience was searching for information on the politics of global warming, it would expected that quite a few searches over a longer duration would be conducted before the student found the information needed. Table 1, below shows assumed search characteristics associated with usurers having different levels of knowledge and experience. These assumptions are used in some embodiments of the invention to generate parameters used to determine whether clicks are fraudulent or not.

TABLE 1

| | Limited Internet | Significant Internet |
|---|---|---|
| | Search Experience | Search Experience |
| Limited Domain | High Number of | Moderate Number |
| Knowledge | Searches | of Searches |
| | Longer Duration | Moderate Duration |
| Significant Domain | Moderate Number of | Low Number of |
| Knowledge | Searches | Searches |
| | Moderate Duration | Brief Duration |

Monitoring the attributes of search-bursts for a specific user can provide valuable insight into the user search behavior, specifically these search-burst attributes can be used to help identify potential click-fraud. Some search-burst attribute values are independent of the user's search experience and are clearly indicative of click-fraud (e.g. high average click & coverage rates). Other search-burst attributes are relative to the user's expertise in formulating searches and need to be monitored over a longer period of time before potential click-fraud can be identified (e.g. a dramatic change in click and coverage rates).

The next step 14 in the method 10 for FIG. 1 is to monitor search relevancy. Search relevancy is a measure of the overall relevance of a given search-burst. Search relevancy can be determined by examining the similarities between searches within a search-burst. Measuring search relevancy is an indicator of whether or not a user is interested in finding specific information, or conversely trying to maximize the number of sponsored-clicks performed as a result of a sequence of searches.

In some optional embodiments of the invention, a step 16 of generating a relevancy coefficient is performed. For example, review the search burst illustrated in Table 2 below.

TABLE 2

| Search | Search String |
|---|---|
| 1 | bmw suv |
| 2 | X3 |
| 3 | “X5” or “X3” |
| 4 | lease suv |
| 5 | bmw lease deal |
| 6 | bmw rebate |
| 7 | X Series |

The search-burst shown in Table 2 contains seven unique search strings. The search string is the terms entered by the user to be searched in a given search. The overall relevancy of the search-burst is determined by comparing each search string in the burst with all of the other search strings in the burst. A higher frequency of pattern matches across searches corresponds to a higher relevancy measure for the search-burst. A pattern match can be defined in any way useful to a system operator. In one example, a pattern match occurs when any of the following conditions are met: 1. a whole word exact-match within the search string; 2. a substring match within a word contained in the search string where a minimum of 5 contiguous characters within the words match.

In some embodiments of the invention, parts of common prefix and suffix substrings are not considered as candidate substrings for matching, e.g. “ing”, “ess”, “tion”, “pre”. Attempts are made to match on root components of a string. In some embodiments of the invention, if two searches match identically, i.e. exact sequence of characters in the entire search-string, no more, no less, then one of the searches is not considered to be part of the search-burst and neither are considered to be a matched-search in the context of an identical match.

Applying the above mentioned matching rules to the seven-search search-burst shown in Table 2, it is apparent that 6 out of 7 searches share at least one match with other searches in the search-burst. A search string that contains at least one match with another search string is defined as a matched-search. Table 3 below is a copy of Table 2 above with the matching terms emphasized to show corresponding matches.

TABLE 3

| Search | Search String |
|---|---|
| 1 | bmw suv |
| 2 | [symbol] |
| 3 | “X5” or “ [symbol] ” |
| 4 | lease suv |
| 5 | bmw lease deal |
| 6 | bmw rebate |
| 7 | X Series |

This matched-search ratio of 6/7 suggests a high degree of relevancy; however, additional insight is gained by weighting the relevancy of each matched search string. Matching search strings are weighted by examining the number of matches within a specific search string. This search burst also contains three matched-searches with two or more substrings that each has an additional match with another search string (i.e. searches 1, 4, and 5). These multi-matched searches are named multi-matches. The multi-match ratio is simply the number of multi-matches divided by the total number of searches within the search burst. For this example, the multi match ratio is 3/7. The relevancy of the search burst can be biased by considering the multi-match ratio as part of the overall relevancy equation. In some embodiments of the invention, a search Relevancy Coefficient for a search burst is defined as:

$$Relevancy Coefficient = \frac{matched \text{-} search\_ratio - \frac{1}{searches}}{1 \text{-} multi \text{-} match\_ratio}$$

For this example, the Relevancy Coefficient for the search burst of Tables 2 and 3 is computed as follows:

$$\begin{matrix}Relevancy Coefficient = \frac{matched \text{-} search\_ratio - \frac{1}{searches}}{1 \text{-} multi \text{-} match\_ratio} \\ = \frac{5 / 7}{4 / 7} \\ = 1.25\end{matrix} \qquad Example 1$$

Table 4 below shows a second example of a search burst.

TABLE 4

| Search | Search String |
|---|---|
| 1 | virtual reality |
| 2 | surfboards |
| 3 | r [symbol] car |
| 4 | mortgage |
| 5 | d [symbol] service |
| 6 | real estate |

The matched-searches and multi-matches are identified in Table 4 in bold italics. The search burst in the second example (shown in Table 4) has only matched searches with no multi-matches. The Relevancy Coefficient for the search burst of Tables 4 is computed as follows:

$$Relevancy Coefficient = \frac{\frac{2}{6} - \frac{1}{6}}{1 - \frac{0}{6}} = \frac{1}{6} = 0.17 \qquad Example 2$$

In other embodiments of the invention, other processes of monitoring search relevancy 14 can be used. Optionally, other formula may be used in accordance with the invention to generate a relevancy coefficient 16 according to the needs of a particular system.

The next step 18 is to monitor click coverage. A user engaged in click fraud may attempt to maximize the amount of click-revenue they can gain by clicking through as many ads as possible within a given search. A useful measure of whether a user is potentially maximizing revenue can be evaluated by examining the average percentage of clicks/(number of search-results) i.e. the click-coverage of a given search. If a user consistently clicks through every (or nearly every) available search result, (i.e. 100% or nearly 100% search click-coverage average) then that user is probably not interested in the product or services offered by the sponsor and is likely committing click-fraud. In some embodiments of the invention, the click coverage is determined as a ratio of links click on verses links presented to the user. Where searches yield large and unwieldy results, the click coverage ratio may be calculated by comparing the links displayed on the screen verses the amount of those links clicked on, or some other useful limitation. In other embodiments of the invention, the click coverage ratio by be defined as links displayed on a website verses those links clicked on. The click coverage ratio is often expressed in terms of a percentage.

The next step 20 described in the method 10 of FIG. 3 is to monitor a click rate. The click rate may be expressed in an amount of clicks per unit of time. It may be averaged over a specific amount of time, a high, a low or some other click rate may be considered. In some embodiments of the invention, an average of clicks per minute is considered in an analysis of a users behavior patterns.

In addition to trying to click-through as many sponsored ads as possible, a user engaged in click fraud is likely to try and click through ads at the fastest possible rate. They would not be interested in viewing the pages they clicked to, but rather moving on to the next revenue generating click. An extremely high search click rate may be indicative of a click bot (an automated program designed to perform searches and click on results).

Table 5 below lists some click rates and characterizes them as high, moderate, and low.

TABLE 5
Click Rates

| | |
|---|---|
| High | ≧10 clicks/minute |
| Moderate | ≧3 clicks/minute and <10 clicks/minute |
| Low | <3 clicks/minute |

The above mentioned click rates may be modified in accordance with the invention to reflect habits of monitored users. For example, a moderate click rate may be raised to include 13 or 15 clicks a minute. Very high click rates such as 18 to 20 or greater may be indicative of a click bot generating clicks.

There are practical and physical limit to human initiated searches and subsequent clicks. Some examples include: performing a search the persists an unreasonable, extended period of time; a click rate that is not physically possible to achieve; an unreasonable number of clicks (and associated page views) within a 24 hour period. Table 6 below specifies an example of operational limits for search behavior parameters that identify click-fraud. Note that leads and qualifying leads are included in determining whether a limit has been exceeded.

TABLE 6

| Search Behavior Parameter | Initial Limit | Description |
|---|---|---|
| Singular Click Rate | 15 clicks/minute | Click rate value at any |
| | | point in a search |
| | | session. |
| Extended Click Rate | 8 clicks/minute | Average click rate over |
| | | any period of time |
| | | exceeding 30 minutes. |
| Clicks per day | 500 | Total number of clicks |
| | | within any contiguous |
| | | 24 hour period |

The limits specified in the table above are examples of operational limits. These limits can be modified and altered to reflect a multiple of the measured average behavior for of users of a search agent. In some embodiments of the invention, once limits are established and click rates are monitored as part of the sentinel metrics, some types of click fraud can be identified in step 2 of the methods 1, 7 shown in FIGS. 1, 2. Thus, the need to perform steps 3, 4, and 8 is obviated and step 6 and then be undertaken as shown in FIGS. 1 and 2.

High click-rates, high search-coverage ratios, and low relevancy coefficients are all indicators of potential click fraud. A high search click-rate is also an attribute of an experienced internet user adept at traversing through clicks to find desired information. A high search-coverage ratio could also be a characteristic behavior of someone trying to gather as much information possible about a specific topic, product or service, i.e. they are reading everything they can on a specific topic to make an informed decision. A low relevancy coefficient is characteristic of someone that is not adept at searching for information. Herein lies the value in looking at the combination of these metrics. If a user's search bursts consistently exhibit a high average search click-rate (experienced user) and a low relevancy coefficient (new user) then expected nominal user search behavior is not consistent. A high average search-coverage ratio would punctuate this behavior as being suspicious in an attempt to maximize the amount of revenue.

Multiple search behavior metrics have been discussed; however, any single metric value on its own will generally not provide as much information to identify click-fraud as well as studying the combination of metrics. Collectively the metrics can be analyzed and suspicious behavior can be isolated in the context of all available metrics.

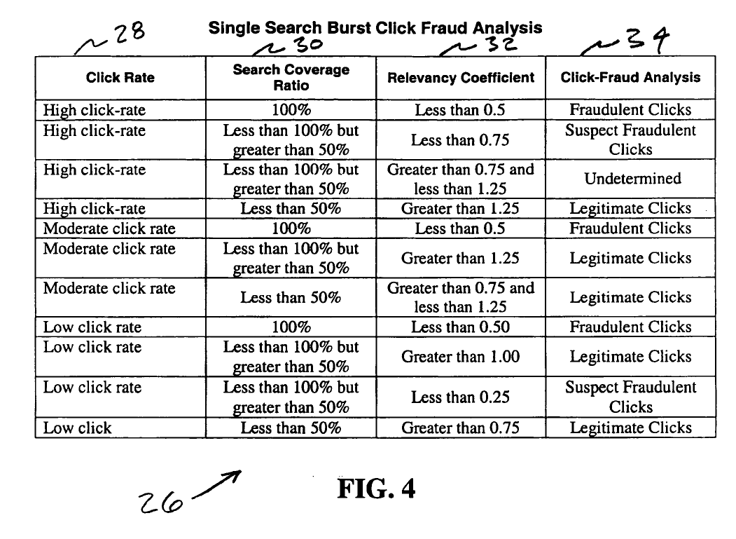

The next step 22 on in the method 10 shown in FIG. 3 is to analyze the monitored metrics. Finally, the clicks being reviewed are characterized in step 24. These search metrics may analyzed and characterized as shown in the table of FIG. 4. In some embodiments of the invention, if the analysis yield an undetermined characterization the method treats these clicks as suspected fraudulent. In other embodiments of the invention they are considered legitimate clicks.

The table shown in FIG. 4 provides a frame work that the monitored metrics of click rate, search coverage ratio, relevancy coefficient can be fit into. As shown in FIG. 4, the first column on the left hand side 28 is for a click rate. Once the click rate is determined, several rows in the table 26 are identified to not longer be relevant to that click rate. A search coverage ratio corresponding to the identified click rate is identified and compared in column 30 and more rows are identified as not relevant to the analyzed data. If more then one row is still relevant to the analyzed data, the relevancy coefficient column 32 is considered with respect to the analyzed data. At this point, only one row will be still relevant to the analyzed data. The click fraud analysis column 34 at the relevant row will identify a characteristic to associate with the clicks being analyzed. After reviewing the invention disclosed herein, the table of FIG. 4 can be modified by one skilled in the art to achieve a desired result for any given situation.

While the table shown in FIG. 4 provides characteristics such as fraudulent clicks, suspect fraudulent clicks, undetermined, and legitimate clicks, these characterizations can be modified according to the needs of a particular analysis. For example the characterizations can be assigned a number or a grade for additional analysis. In some embodiments of the invention, the characterization categories may be expanded or reduced. In other embodiments of the inventions the numeric values found in the columns are rows may be modified, expanded or reduced.

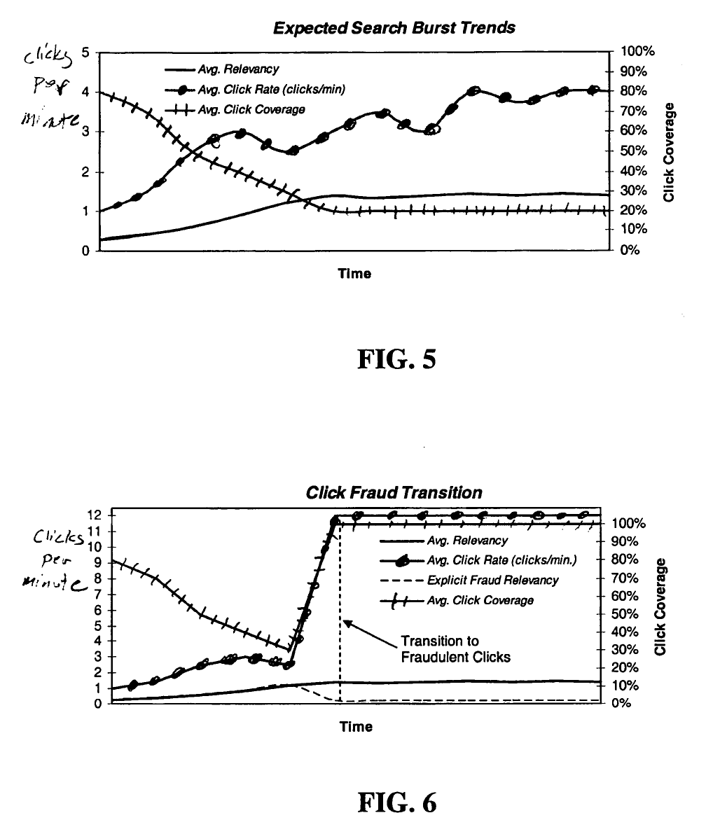

Another tool in determining whether an internet user is engaged in click fraud it to analyze click behavior over time. Some times referred to as historical analysis. Changes in click behavior can be indicative of an internet user becoming more proficient at searching, forming improved, more relevant search strings, or simply adopting more frequent usage of a particular proprietary search technology (i.e. key words) used with some search engines. Changes in click behavior may also be indicative of a user trending toward fraudulent click behavior. FIGS. 5-8 show and the following text discusses click behavior trends and some expected search burst patterns over time.

A typical learning curve representing a new internet user gaining experience and skill at conducting internet searches is shown in FIG. 5. It is expected that individual internet users develop internet search skills with increasing internet search experience. The learning curve may be reflected in an analysis of search burst parameters discussed above over time.

In addition to internet searchers becoming more skilled at formulating relevant search strings to target the focus topic of their search an increase in average search-burst relevancy should occur over time. Similarly, hand-eye-mind search skills are honed with additional experience enabling internet users to click on a link, quickly scan the page to determine if it is of interest, and if not of interest then click on the next link in the search. As this skill is developed, the average click rate should trend up over time and plateau.

With better formed search strings come better results; consequently internet users do not need to click on as many results because the result set contains a rich set of links that more directly address the focus topic of the search. Consequently, internet users do not need to look in as many places to find what they are looking for and the click coverage ratio will trend down over time. Over time all three of these search-burst parameter averages tend to stabilize with some minimal variations.

In contrast to the learning curves shown in FIG. 5, an experienced internet user new to being monitored for click fraud would have flat trend lines for these search burst parameter averages as they have already honed their internet search skills.

Abrupt deviations in the search-burst trends are indicative of click fraud. (See FIGS. 6-8) An internet user that is on the nominal trend line pattern will produce inflection points in the trend when their behavior shifts to fraudulent clicks. The primary objective of an internet user initiating fraudulent clicks is to maximize rewards through click-revenue, relevancy of the search string and resulting click pages is likely not of concern.

On some networks, such as the Crossites network, repurposed click-revenue is associated with each click in Crossites, the average search-burst click rate would increase among fraudulent users of Crossites. Note that all three search burst parameters would not necessarily change when a user initiates fraudulent behavior. (See FIG. 6.) For example, the user may choose to exhaust every link presented by Crossites within a legitimate search; consequently, the average click coverage would approach 100% while the average relevancy trend line would not necessarily decrease. This could easily be construed as a mild form of click-fraud in that the user is still using the technology for legitimate searches, but opts to maximize repurposed revenue by continued to click on search results even though he may have found what he was looking for. A more explicit indicator of click fraud is the relevancy trend line (shown in FIG. 6 as a vertical dashed line) significantly dipping simultaneously with the click-coverage and click rates increasing.

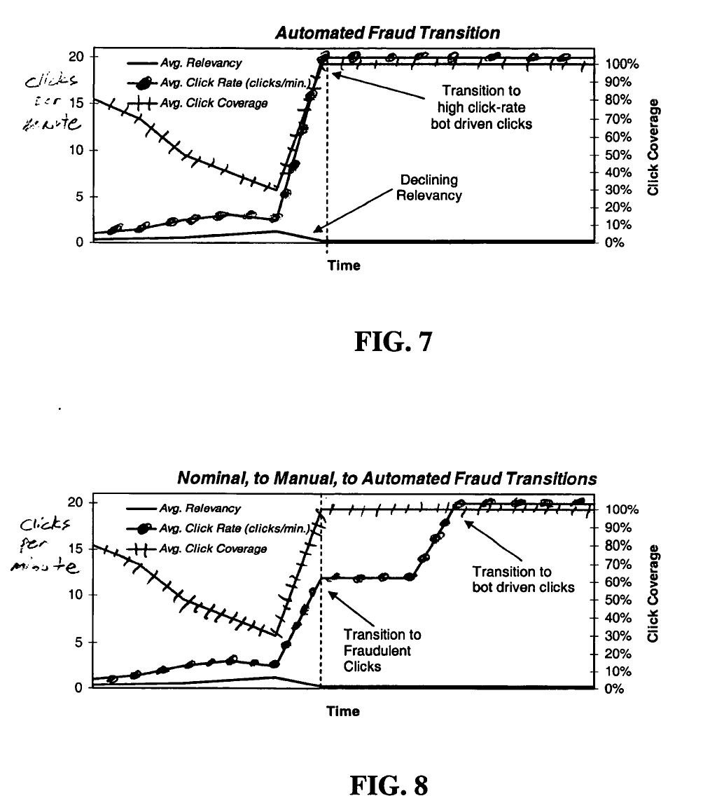

Users who choose to employ an automated “bot” to perform search and click-throughs should be easier to identify. The tell-tale indicator of a bot is a high click-rate and click-coverage approaching 100%. (See FIG. 7) Relevancy would likely be low if the bot is randomly generating the search string. The transition from nominal usage to bot based fraudulent behavior should be dramatic with strong inflection points observed during the transition period.

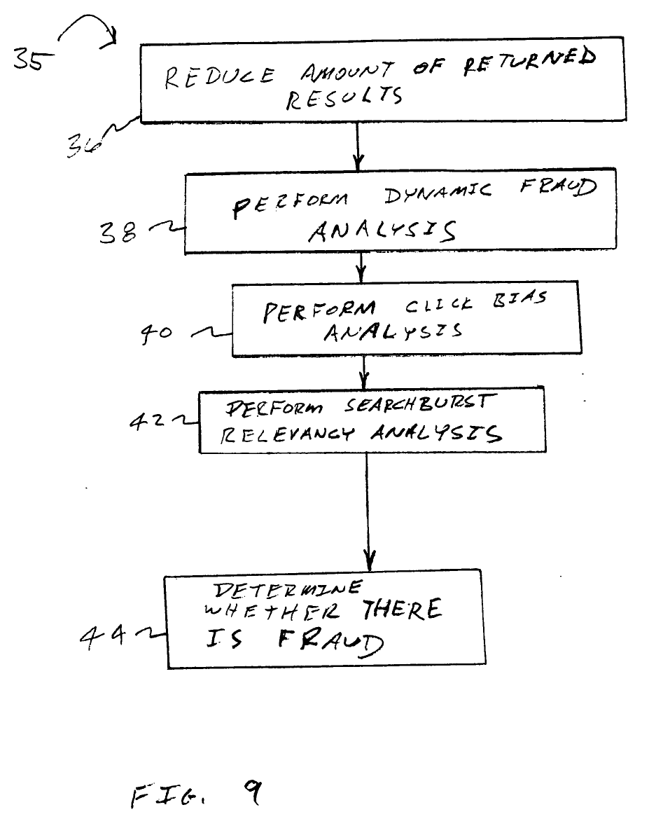

Another likely scenario is a multiple transition from nominal usage, to manual fraud, to bot based fraud as shown in FIG. 8.

Returning to FIG. 2, the analysis performed in step 8 of the method 7 will now be discussed. When the analysis performed in step 4 of method 7 is insufficient to determine whether a pattern of clicks constitute click fraud or not, additional analysis is done in step 8. FIG. 9. illustrates a optional method 35 for performing additional analysis on a pattern of clicks performed by a user.

In the method 35 shown in FIG. 9 an amount of links (and/or leads and qualified leads) presented as a result of a search request is reduced. This can be done in step 4 or the amount of links (and/or leads and qualified leads) can be further reduced in step 36.

Search click bias metrics are dynamically generated by controlling the number of times Crossites ads are presented to the member over a fixed number of searches. For example, if a series of 20 searches would normally result in 18 of those searches returning Crossites ads, then Crossites would only return 10 searches with ads. In this scenario we would see 10 searches where Crossites did not return any ads and the search engine ads were the only ads presented for those 10 searches. This dynamic control of withholding Crossites ad presentation provides a microcosm of experience that can be used to more precisely examine member behavior and assess their motives for search.

Further analysis at this stage of click patterns by the user is sometimes referred to as dynamic fraud analysis 38. Dynamic fraud analysis 38 can be conducted on existing click patterns generated by a user, additional click patterns continually generated by a user as the user continues to conduct additional searches or a combination of both.

With the exception of some metrics that have specified absolute limits, it is difficult to ascertain click-fraud from any singular metric. Analyzing multiple metrics within the context of a specific set of searches and associated clicks can improve the confidence of a click-fraud determination. The pragmatics of performing a comprehensive analysis of every search and click of every member can be expensive. In some embodiments of the invention, the method 7 only monitors a subset of the available metrics for every member until a member becomes suspect of committing click-fraud. This subset of metrics are referred to as sentinel metrics. Once a sentinel metric has been tripped for suspicious behavior, then additional analysis of past search and click data are performed. If this additional analysis suggests that a user may be engaged in click-fraud, then more extensive (and possibly expensive) dynamic and deterministic methods are employed to assess the member's motives.

In general (but not always), click-fraud metrics generation and analysis are not performed real-time. A method in accordance with the invention employs dedicated resources to analyze search and click behavior after the searches and clicks have been performed. Click-fraud analysis is performed prior to billing a sponsor. Clicks incurred by a suspicious member are not billed to the sponsor until a final determination of the click-fraud has been made.

If click-fraud suspicion for a member has been escalated as a result of one or more sentinel metrics being tripped (step 2) and the additional analysis (step 4) indicates click-fraud is likely, then click-fraud suspicion is escalated to high and dynamic real-time method of analysis is employed (step 8).

In some embodiments of the invention, the dynamic fraud analysis can include performing a click bias analysis. A insightful method of analyzing member behavior is to compare how a user behaves when the user is only presented with search engine results, versus searches where both search engine results and the permissive agent search results are presented. An assumption is made here that a user will click-through the permissive agent results prior to any search-engine results because of the incentive associated with click-throughs on permissive agent ads. Using metrics already discussed such as click-rate, clicks/search, and others, a determination of user bias towards the permissive agent can be determined and used as part of the overall analysis to assess whether a user is engaged in click-fraud. The general form of the equation for determining click bias metrics is:

$$Bias = 1 - \frac{SearchEngineOnlyClickMetric}{PermissiveAgentOnlyClickMetric}$$

For example, in a scenario where a user is only clicking on ads presented by the permissive agent, but never clicks on search-engine ads even when the permissive agent does not present any ads. Assume the user performs 10 searches, where the permissive agent returned results in 3 of the 10 searches. Assume that the user has an average click per search of at least 1 click for each of the searches that permissive returned ads for. In this scenario, the user did not click through any of the search results returned by the search-engine for the 7 searches where the permissive agent did not return an ad, i.e. the average clicks-per-search for search engine only results is 0.

$$ClicksPerSearchBias = 1 - \frac{0}{1} = 1$$

In this example the clicks per search Bias=1. The strong bias towards only clicking on the permissive agent ads calls the motives of the user into question and suggests that many if not all of these clicks are fraudulent.

The next step 42 in the method 35, which is a subpart of step 8 in some embodiments of the invention, is to determine and analyze a Search Burst Relevancy Bias. This metric is determined by the following equation:

$$SearchBurstRelevancyBias = 1 - \frac{1 / AverageSearchEngineOnlySearchBurstRelevancy}{1 / AveragePermissiveAgentSearchBurstRelevancy} = 1 - \frac{AveragePermissiveAgentSearchBurstRelevancy}{AverageSearchEngineOnlySearchBurstRelevancy}$$

The numerator is determined by averaging the search burst relevancy over time for search bursts that return permissive agent ads and the user clicks on ads. The denominator is determined by averaging the search burst relevancy over time for search bursts that may return permissive agent ads, but the member only clicks through on either ads or non-sponsored links in the search engine result set. The search burst relevancy measured in the denominator is likely reflective of search bursts where the user is not interested in a purchase, but rather may be performing research that does not involve the purchase of a product or a service (e.g. researching a current event, or performing research for a school science project). The denominator is a more accurate reflection of the user's skill to construct relevant search strings. If the Search Burst Relevancy Bias is close to zero, then the user is likely not injecting fraudulent search strings just to render permissive agent ads.

In summary, in some embodiments of the invention, difference analyses are used depending on the level of suspicion that a group of clicks are fraudulent. Table 7 below summarizes the type of analyzes used at various levels of suspicion.

TABLE 7

| Member Click Fraud | |
|---|---|
| Status | Analysis Mode |
| Not Suspect | Monitor sentinel metrics |
| Suspect | Analyze historical data |
| Fraud Determination | Dynamic fraud analysis |
| Fraudulent | n/a |

In some embodiments of the invention, the method of detecting click fraud is used with a permissive agent such as, the Crossties technology. Crossties technology permits analysis of user behavior from a unique perspective; metrics have been developed to exploit the vantage point of the permissive agent. These metrics are based on characterizations of user search behavior patterns that can be measured by Crossites. These fundamental behavior patterns include search-burst, search click-coverage, search click rates, and search relevancy. Table 8 below describes some of these metrics.

TABLE 8

| Metric | Brief Description |
|---|---|
| Search Click Rate | The number of sponsored-ad |
| | clicks/minute within a search. |
| Daily Click Rate | The number of sponsored-ad |
| | clicks/day |
| Search-Burst Relevancy | A metric that characterizes the |
| Coefficient | relevancy of searches within a search- |
| | burst. The value is associated with |
| | the search-burst and not an individual |
| | search. |
| Search-Bursts/Day | The number of search-bursts/day |
| Search-Click Coverage Ratio | This metric determines the |
| | percentage of direct-sponsored ads |
| | clicked out of the direct-sponsored |
| | ads returned from a given search. |
| Average Searches/Search-Burst | This metric identifies the average |
| | number of searches per search-burst |
| | for the user. |
| Search Burst Click Coverage Ratio | The average of search-click coverage |
| | ratios across a search burst. |
| Average Click Coverage Ratio | The average of search-click coverage |
| | ratios across the lifespan of a user. |

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A method of detecting click fraud comprising:
monitoring links clicked on by a user;
adjusting search results presented to a user in response to a user's search when the user clicks on links associated with the search results in a pattern that fall within pre-determined parameters.

2. The method of claim 1, further including analyzing links clicked on by the user when presented with the adjusted search results.

3. The method of claim 2, wherein the analyzing links clicked on by the user includes comparing links clicked on presented in a first set of search results and links clicked presented in a set of second search results.

4. The method of claim 3, wherein the analyzing links clicked on by the user includes determining a click bias.

5. The method of claim 2, wherein the analyzing links clicked on by the user includes determining a search burst relevancy bias.

6. The method of claim 1, further comprising taking action with respect to a user's account if clicks associated with the users account are determined to be fraudulent.

7. The method of claim 1, wherein monitoring the links clicked on by a user includes:
detecting a search burst;
monitoring search relevancy of searches in the search burst;
monitoring click coverage ratio of search results;
monitoring click rate of search results;
analyzing the search relevancy of searches in the search burst, the click coverage of search results, and the click rate of search results; and
determining whether the user clicks on links associated with the search results in patterns that fall within the pre-determined parameters.

8. The method of claim 7, further comprising assigning a relevance coefficient to the searches in the search burst.

9. The method of claim 8, wherein relevance coefficient is determined by using the formula:
$$\frac{matched \text{-} search\_ratio - \frac{1}{searches}}{1 \text{-} multi \text{-} match\_ratio} .$$

10. The method of claim 9, wherein the user clicks on links associated with the search results in a pattern that fall with pre-determined parameters if any one of the following three conditions occur:
(a) the click coverage ratio is over about 50% and the relevancy coefficient is less than about 0.75;
(b) the click coverage is between about 50% and 100% and the relevancy coefficient is between about 0.75 and 1.25; and
(c) the click coverage ratio is over about 50% and the relevancy coefficient is less than about 0.25 and the click rate is less than about 3 clicks per minute.

11. The method of claim 9, further comprising not adjusting search results presented to the user because the user clicks on links associated with the search results in a pattern that does not fall with pre-determined parameters when any one of the following three conditions occur:
(a) the click coverage ratio is below 100%, the click rate is between about 3 and 10 clicks per minute, and the relevancy coefficient is at or above 1.25;
(b) the click coverage ratio is below 100%, the click rate is at or below 3 clicks per minute, and the relevancy coefficient is at or above about 1.00; and
(c) the click coverage ratio is below 100%, the click rate is at or below 3 clicks per minute, and the relevancy coefficient is at or above about 0.75.

12. The method of claim 7, further comprising not adjusting the search results presented to the user because the user clicks on links associated with the search results in a pattern that does not fall with pre-determined parameters when the click coverage ratio is less than about 50%.

13. The method of claim 7, wherein the user clicks on links associated with the search results in a pattern that falls with pre-determined parameters if the click rate achieves and one of the three following conditions:
(a) the click rate is about 15 clicks per minute;
(b) the click rate is about 8 click per minute for at least about 30 minutes; and
(c) the click rate exceeds about 500 clicks per day.

14. The method of claim 7, wherein the user clicks on links associated with the search results in a pattern that falls within pre-determined parameters if the click coverage ratio approaches 100%.

15. The method of claim 2, wherein analyzing the user's clicks with respect to the altered search results includes monitoring steps are done over a length of time with several different search bursts and determining that the clicks are fraudulent if they are part of a second pattern of click behavior.

16. The method of claim 15, wherein the user clicks on links associated with the search results in patterns that fall within the second pattern of click behavior if the search relevancy declines over time.

17. The method of claim 15, wherein the user clicks on links associated with the search results in patterns that fall within the second pattern of click behavior if the click coverage and the click rate increase over time and the search relevancy declines over time.

18. The method of claim 1, further comprising adjusting internet advertising fees based on the characterized clicks.

19. The method of claim 1, wherein a user making the clicks elects to be monitored.

20. The method of claim 1, further comprising taking action against a user of the system if it is detected that the user is generating fraudulent clicks.

21. The method of claim 1, wherein the adjusting the search results step includes one of the following steps:
(a) stopping the presentation of search results;
(b) reducing the number of search results presented; and
(c) eliminating the presentation of particular types of search results presented.

22. A method of detecting click fraud behavior comprising:
monitoring a pattern of clicks on links presented to a user as a result of a search request by the user;
adjusting the search results presented to the user in future search requests when past search requests from that user result in the user forming a pattern of clicking on links presented in the past search results according to predetermined parameters; and
conducting additional analysis of the links clicked on by the user in the adjusted search results and based on the additional analysis doing one of the following two steps:
resuming the presentation of search results to the user to a pre-adjusted level; and
stopping the presentation of search results to the user.

23. The method of claim 22, wherein the monitoring step includes monitoring sentinel metrics.

24. The method of claim 23, wherein the conditioning additional analysis includes performing a historical analysis on the click pattern.

25. The method of claim 24, further comprising performing a dynamic fraud analysis if the historical analysis is indeterminate.

26. A method of detecting click fraud behavior comprising:
monitoring a pattern of clicks on links presented to a user as a result of a search request by the user; and
conducting additional analysis of the links clicked on by the user if the monitored pattern of clicks falls within pre-determined parameters.

27. The method of claim 26, wherein the monitoring step includes monitoring sentinel metrics.

28. The method of claim 26, wherein the conditioning additional analysis includes performing a historical analysis on the click pattern.

29. The method of claim 26, further comprising performing a dynamic fraud analysis if the historical analysis is indeterminate.
